(19) United States
(12) Patent Application Publication
(10) Pub. No.: US 2009/0301513 A1
(43) Pub. Date: Dec. 10, 2009

(54) Disposable Dental Whitening Toothpick

(76) Inventors: Joseph Scott Freeman, Candler, NC (US); Jennifer Thomas, Candler, NC (US)

Correspondence Address: Joseph Scott Freeman, PO Box 183, 72 Conner Road, Candler, NC, 28715, US

(21) Appl. No.: 12/133,799

(22) Filed: Jun. 5, 2008

(51) Int. Cl. A61C 15/02

(52) U.S. Cl. 132/321

(57) ABSTRACT

The present invention relates to teeth and mouth cleaning devices, and more particularly to a simple disposable teeth-whitening toothpick. A coating of a teeth-whitening compound is applied to the toothpick. The coating may be flavored in order to enhance user enjoyment. The coating is chemically bonded to the toothpick, and dissolves when it comes in contact with saliva.

### FIELD OF THE INVENTION

The present invention relates to teeth and mouth whitening devices, and more particularly to a simple disposable dental whitening toothpick.

### BACKGROUND OF THE INVENTION

A growing market has developed for tooth-whitening products as individuals seek simple, cost-effective methods to obtain cleaner and whiter teeth. Various chemicals are currently available to achieve this objective, but can be expensive and time-consuming. The present invention would allow a person to help whiten their teeth with a simple wooden toothpick that may be used after meals, when it is desirable to rid the mouth of trapped food particles.

A coating is bonded to a common wooden toothpick. The coating dissolves when it comes in contact with saliva.

### SUMMARY OF THE INVENTION

Recent and ongoing strides in preventive dentistry owe much to the research work that has provided, for the first time, a scientific explanation for the processes of tooth decay and gum disease. Although bacteria had long been implicated in tooth decay, in combination with sugar and other simple carbohydrates, the specific process of tooth decay was not understood until fairly recently. Tooth enamel is not a particularly favorable environment for the decay-causing bacteria. However, other types of bacteria are able to flourish on tooth enamel, and as they grow, a thin layer or film is formed on the tooth surface. This film, known as plaque, creates a favorable matrix or medium in which the cavity-causing bacteria can grow. Among the by-products of this growth, the rate of which depends upon the amount and nature of the sugars and simple carbohydrates, are various organic acids that attack the enamel and ultimately produce cavities. The plaque layer also serves to keep these acidic by-products adjacent the tooth enamel, protecting them from the various mechanical abrasive elements normally existing in a person's mouth.

Plaque is also a major contributing factor of periodontal gum disease. Unless removed, the plaque layer becomes thicker and starts hardening into a material known as tartar or calculus. This transformation occurs first and most easily on those areas of the tooth that do not receive mechanical abrasion, such as around the base of the teeth, and at the tooth/gum interface. This build-up of calculus irritates the adjacent gum tissue, causing it to pull away from the tooth. The retreat of gum tissues opens additional areas of the tooth surface to attack, causing additional gum tissue regression. If unchecked, this process results in not only the loss of the involved tooth, but also in the destruction of the surrounding bone tissue of the jaw.

The key to preventive dental hygiene is cleaning the teeth and gums as soon after eating or drinking as possible. Complete cleaning, including brushing with a conventional toothbrush and flossing with any floss, is the preferred method of cleaning the teeth after eating. When away from home, however, the principal difficulty with the foregoing devices is that one must have on hand a toothbrush, toothpaste, and floss, and have access to water, in conjunction with their application of mechanical action. When dining away from home, it is difficult to obtain the required privacy and a source of water. Even though dental floss does not require water, public flossing has yet to be declared socially acceptable. Toothpicks are presently the only public dental cleaning device that has found social acceptability.

Thus, here is presented a consumer-oriented dental device suitable for use after meals eaten away from home (and at home if desired). Other than the ineffective technique of rinsing with various mouthwashes, the only present alternative to maintaining good oral hygiene after eating a meal when away from home is to bring a toothbrush and use it in a restroom, a practice that is not common for a number of understandable reasons.

### BRIEF DESCRIPTION OF THE DRAWINGS

FIG. 1 shows a toothpick that has been treated with a dental-whitening solution.

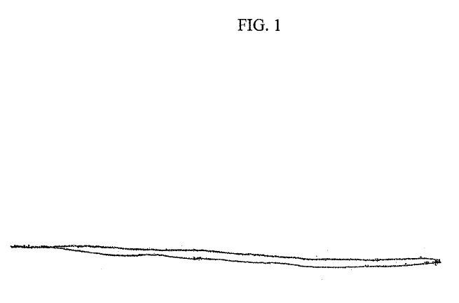

### DETAILED DESCRIPTION OF A PREFERRED EMBODIMENT

In its preferred embodiment, the method for manufacturing the dental whitening toothpicks consists of treating plain wooden toothpicks with a solution of water, hydrogen peroxide, baking soda, and mint flavoring. The wooden toothpicks may be sprayed with a solution of water, hydrogen peroxide, baking soda, and mint flavoring, or may be soaked in such a solution. The dental whitening toothpicks are then dried and packaged for distribution.

While the invention has been particularly shown and described with reference to specific embodiments thereof, it will be understood by those skilled in the art that various other changes in the form and details may be made without departing from the spirit and scope of the invention. Accordingly, the proper scope of the invention is defined by the appended claims.

What is claimed is:

1. A toothpick that has been treated to clean an individual's teeth when used thereon.

2. A toothpick constructed of wood or cellulose material that has been treated to clean an individual's teeth when used thereon.

3. A toothpick constructed of wood or cellulose material that has been treated with a solution of hydrogen peroxide and baking soda to clean an individual's teeth when used thereon.

4. A toothpick constructed according to claim 3, wherein said toothpick contains a flavored coating in order to enhance user enjoyment.
